(19) United States
(12) Patent Application Publication
(10) Pub. No.: US 2024/0343036 A1
(43) Pub. Date: Oct. 17, 2024

(54) PRINTING PRESS AND METHOD FOR PRODUCING VARIABLE SHEET LENGTHS

(71) Applicant: manroland Goss web systems GmbH, Augsburg (DE)

(72) Inventors: Theo Keilhau, Neusäß (DE); Josef Singler, Binswangen (DE); Thomas Hartmann, Mering (DE)

(73) Assignee: manroland Goss web systems GmbH, Augsburg (DE)

(21) Appl. No.: 18/631,409

(22) Filed: Apr. 10, 2024

(30) Foreign Application Priority Data
Apr. 14, 2023 (DE) 10 2023 109 491.2

(51) Int. Cl. B41F 13/60; B41F 5/06; B41F 13/62; B41F 13/64

(52) U.S. Cl. CPC B41F 13/60; B41F 5/06; B41F 13/62; B41F 13/64

(57) ABSTRACT

A printing press and a method for printing a printing material web wherein the change of the print image length and/or of the sheet length is possible in the shortest time. The printing press includes at least one first printing unit for at least one-sided printing of the printing material web with a first print image with a first print image length, at least one second printing unit for at least one-sided printing of the printing material web with a second print image with a second print image length deviating from the first print image length, and a cross-cutting means for separating the printing material web into sheets with a sheet length that corresponds to the first print image length or to the second print image length or to the quotient of the first print image length or of the second print image length and an integer greater than zero.

### FIELD OF THE INVENTION

The invention relates to a printing press for printing a printing material web, as well as a method for printing a printing material web.

### BACKGROUND AND RELATED ART

Web-fed printing presses, which comprise a plurality of printing units, are known for printing printing material webs, which are subsequently separated and, if necessary, processed into folded signatures for newspapers, brochures, notebooks, catalogs or books.

EP 1 803 560 A1 thus discloses a web-fed printing press comprising a plurality of printing units arranged next to one another for alternately printing the printing material web to avoid downtimes and setup times.

EP 0 862 999 A2 also discloses a web-fed printing press comprising a plurality of printing units arranged downstream of the web running direction for optionally alternately printing the printing material web to avoid downtimes and waste.

All of the web-fed printing presses known from the prior art have the feature that these printing units each have the same format, that is, the same print image length and thus the same cylinder diameter, so that even though the printing material web can initially be printed sequentially by means of at least a first printing unit and subsequently by means of at least a second printing unit, the first as well as the second printing unit can have the same print image length, however, so that the printing material web is always printed with the same print image length, which is also understandable with regard to the object disclosed therein because only the print image is to be changed with as little downtimes and low waste as possible, which requires maintaining the print image length and thus the cut-off length and the fold type.

Printing presses, in the case of which the print image length as well as the cut-off length can be changed by exchanging components of the printing units and/or of the folder, are further known from the prior art. However, the conversion from a first print image length and/or cut-off length to a second print image length and/or cut-off length requires a high expenditure of time for the mostly complex conversion of the machine on the one hand, and a high effort from trained personnel is necessary and requires the stocking, storing and maintaining of the respective unnecessary components on the other hand.

### OBJECT AND SUMMARY OF THE INVENTION

It is thus the object of the invention to create a printing press, by means of which the variation of the print image length and/or of the sheet length is made possible within the shortest possible time and mechanical interventions in the printing press are minimized at the same time.

The object is attained by means of a printing press for printing a printing material web, which comprises at least one first printing unit for the at least one-sided printing of the printing material web with a first print image with a first print image length L1, wherein the at least one first printing unit is designed for the print-free guide-through or guide-around of the printing material web, at least one second printing unit for the at least one-sided printing of the printing material web with a second print image with a second print image length L2 deviating from the first print image length L1, wherein the at least one second printing unit is designed for the print-free guide-through or guide-around of the printing material web, a cross-cutting means, which is formed for separating the printing material web into sheets with a sheet length LB, wherein the sheet length LB optionally corresponds at least to the first print image length L1 or to the second print image length L2 or to the quotient of the first print image length L1 or of the second print image length L2 as numerator and an integer of greater than zero as divisor.

The object is further solved by means of a method, in the case of which unfolded or folded sheets with at least a first sheet length LB1 or a second sheet length LB2 are produced, wherein a printing material web is either printed by means of an at least one first printing unit with a first print image length L1 or by means of an at least second printing unit with a second print image length L2, wherein the printing material web is separated after the printing by means of a cross-cutting means into sheets with a sheet length LB, wherein the sheet length LB is set to the first print image length L1 or to the second print image length L2 or to the quotient of the first print image length L1 or of the second print image length L2 with a whole integer as divisor as a function of the performed first print image length L1 or of the second print image length L2.

A printing press of this type and a method of this type have the advantage that a plurality of print image lengths can be attained therewith without time-consuming retrofitting or conversion of the printing units and without mechanical interventions, which leads to short conversion times on the one hand and to a low error rate by avoiding mechanical interventions by the operating personnel on the other hand.

According to one aspect of the invention, the at least one first printing unit and/or the at least one second printing unit are designed with invariable print image lengths L1, L2. This provides for a standardized pre-print stage with defined printing form sizes and avoids any kind of effort and storage for possible format changes, in particular because it is generally sufficient to fall back on defined, differentiated standard formats and thus standard print image lengths.

According to a further aspect of the invention, the first printing unit and the second printing unit are designed as offset printing units or as flexo printing units or as letterpress printing units or as gravure printing units. These printing methods have the advantages of a high printing speed, of a high print-run stability and of a high print quality as well as of a highly economical production of printed products in the average to very high run length.

According to a further aspect of the invention, a folding device is arranged downstream from the cross-cutting means. This provides for the production of folded printed products inline in the printing press.

According to a further aspect of the invention, the folding device is designed for the optional collecting and/or cross-folding and/or longitudinal folding of the sheets. This provides for the production of so-called notebooks as well as for ensuring a maximum production flexibility.

### BRIEF DESCRIPTION OF THE DRAWINGS

Further embodiments of the invention follow from the following detailed description and accompanying drawings. Various exemplary embodiments of the invention will be described in more detail on the basis of the accompanying drawings, without being limited thereto.

FIG. 1 shows a schematic illustration of a printing press comprising printing units with different print image lengths each and turned-off second printing unit.

FIG. 2 shows a section of a printing material web printed according to the configuration shown in FIG. 1.

FIG. 3 shows a schematic illustration of a printing press comprising printing units with different print image lengths each and turned-off first printing unit.

FIG. 4 shows a section of a printing material web printed according to the configuration shown in FIG. 3.

### DETAILED DESCRIPTION OF EMBODIMENTS OF THE INVENTION

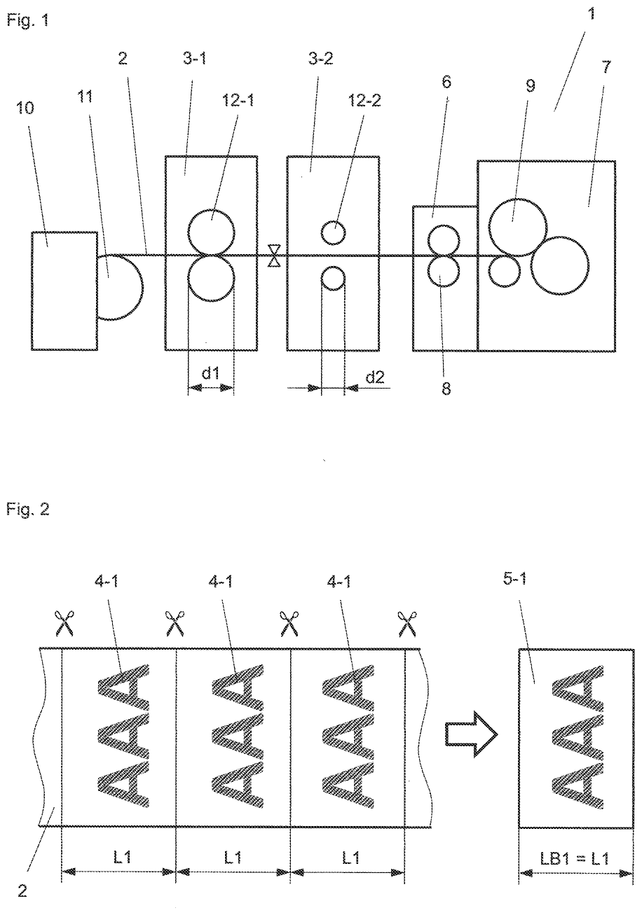

FIG. 1 shows a printing press 1 for printing a printing material web 2, wherein the printing material web 2 is unwound from a printing material roll 11 clamped into a roll changer 10. Instead of the mentioned roll changer 10, an unwinder or unroller can likewise be used.

The printing press 1 further comprises a first printing unit 3-1, which is illustrated purely schematically and by means of which the printing material web 2 can be printed at least on one side with a first print image 4-1, wherein the first print image 4-1 has a first print image length L1. This first printing unit 3-1 comprises at least one first printing cylinder 12-1, which carries the printing form, and which can be formed as form cylinder, plate cylinder and/or transfer cylinder and/or impression cylinder as a function of the printing method. The first print image length L1 thereby corresponds to the circumference of the form cylinder because, in response to an overrolling, the first print image 4-1 applied to the jacket surface is transferred directly or indirectly to the printing material web 2 by means of said form cylinder. The first printing unit 3-1 thus has a first printing cylinder 12-1 with a first printing cylinder diameter d1, the circumference of which determines the first print image length L1.

The printing press 1 further comprises a second printing unit 3-2, which is illustrated purely schematically and by means of which the printing material web 2 can be printed at least on one side with a second print image 4-2, wherein the second print image 4-2 has a second print image length L2. This second printing unit 3-2 comprises at least one second printing cylinder 12-2, which carries the printing form, and which can be formed as form cylinder, plate cylinder and/or transfer cylinder and/or impression cylinder as a function of the printing method. The second print image length L2 thereby corresponds to the circumference of the form cylinder because, in response to an overrolling, the second print image 4-2 applied to the jacket surface is transferred directly or indirectly to the printing material web 2 by means of said form cylinder. The second printing unit 3-2 thus has a second printing cylinder 12-2 with a second printing cylinder diameter d2, the circumference of which determines the second print image length L2.

The first print image length L1 differs from the second print image length L2, which means that the first printing cylinder diameter d1 differs from the second printing cylinder diameter d2, which is illustrated concretely on the basis of the printing cylinders 12-1 and 12-2 of significantly different sizes in FIG. 1 with a second printing cylinder diameter d2, which deviates significantly from the first printing cylinder diameter d1.

The at least one first printing unit 3-1 as well as the at least one second printing unit 3-2 are designed in such a way that the printing material web 2 can either be guided in a print-free manner through the respective printing unit 3, that is, without being printed in the respective first printing unit 3-1 or in the respective second printing unit 3-2, or that the printing material web 2 can be guided around the at least one first printing unit 3-1 and around the at least one second printing unit 3-2, which can be realized, for example, by a guide-around of the printing material web 2 below or above the respective printing unit 3. In an exemplary manner, FIG. 1 shows the contact-free guide-through of the printing material web 2, which is printed by means of the first printing unit 3-1, through the second printing unit 3-2, which can be attained by means of a correspondingly wide turn-off of the second printing cylinder 12-2.

The printing press 1 illustrated in FIG. 1 further comprises a cross-cutting means 6 for separating the preferably printed printing material web 2 into individual sheets 5, which have a sheet length LB after the separation of the printing material web 2 into sheets 5. The cross-cutting means 6 is formed such that the actual sheet length LB can be varied, so that the sheet length LB optionally corresponds to the first print image length L1 or to the second print image length L2 or to a quotient of the first print image length L1 or of the second print image length L2 as numerator and an integer of greater than zero as divisor.

The cross-cutting means 6 is thus configured in such a way that the sheet length LB is as large as the first print image length L1 or as the second print image length L2. The cross-cutting means 6, however, is preferably also designed to divide the first print image length L1 into a plurality of sheets 5, so that, for example, the first print image length L1 or the second print image length L2 is divided and separated into, for example, two, three or four sheets 5. It is thus possible to arrange several different print images 4 on a first print image length L1 or on the second print image length L2, so that the sheets 5 separated from a print image length L can either be gathered up into a signature or that a plurality of uses and thus a plurality of usable sheets 5 can be produced by means of an overrolling of a printing cylinder 12.

Even though FIG. 1 illustrates a printing press 1 comprising only a first printing unit 3-1 and only a second printing unit 3-2 purely schematically, it goes without saying that a printing press 1 of this type according to the invention can also have a plurality of first printing units 3-1 and/or a plurality of second printing units 3-2 in order to be able to print the printing material web 2 in multiple colors and/or with changing subjects, if necessary, with a constant first print image length L1 or second print image length L2.

Even though the printing press 1 illustrated in FIG. 1 is illustrated only with a first printing unit 3-1 with a first print image length L1 and with a second printing unit 3-2 with a second print image length L2, the invention thus also can include a printing press 1, which comprises at least one further non-illustrated printing unit 3 with a further print image length L, wherein the at least one print image length L of the at least one further printing unit 3 differs from the first print image length L1 and the second print image length L2. It is thus possible, for example, that the printing press 1 comprises at least one third printing unit 3-3 with a third print image length L3 and thus a third printing cylinder diameter d3, wherein the third print image length L3 is different from the first print image length L1 and from the second print image length L2. It is furthermore possible that in addition to the at least one third printing unit 3-3, the printing press 1 comprises at least a fourth printing unit 3-4 with a fourth print image length L4, wherein the fourth print image length L4 differs from the third print image length L3, deviating from the second print image length L2 and from the first print image length L1.

The at least one first printing unit 3-1 and/or the at least one second printing unit 3-2 as well as each further possible printing unit 3 not illustrated in FIG. 1 can be designed as printing unit 3 with an invariable print image length L, namely an invariable first print image length L1 or an invariable second print image length L2. This can be attained, for example, by means of fixed-format offset printing units or by means of fixed-format letterpress printing units.

Alternatively, it is also possible to design the at least one first printing unit 3-1 and/or the at least one second printing unit 3-2 as well as each further possible printing unit not illustrated in FIG. 1 as printing unit 3 with a variable print image length L, namely a variable first print image length L1 or a variable second print image length L2. This can be attained, for example, with the use of format-variable offset printing units or with the use of format-variable flexo printing units or as format-variable letterpress printing units or as gravure printing units.

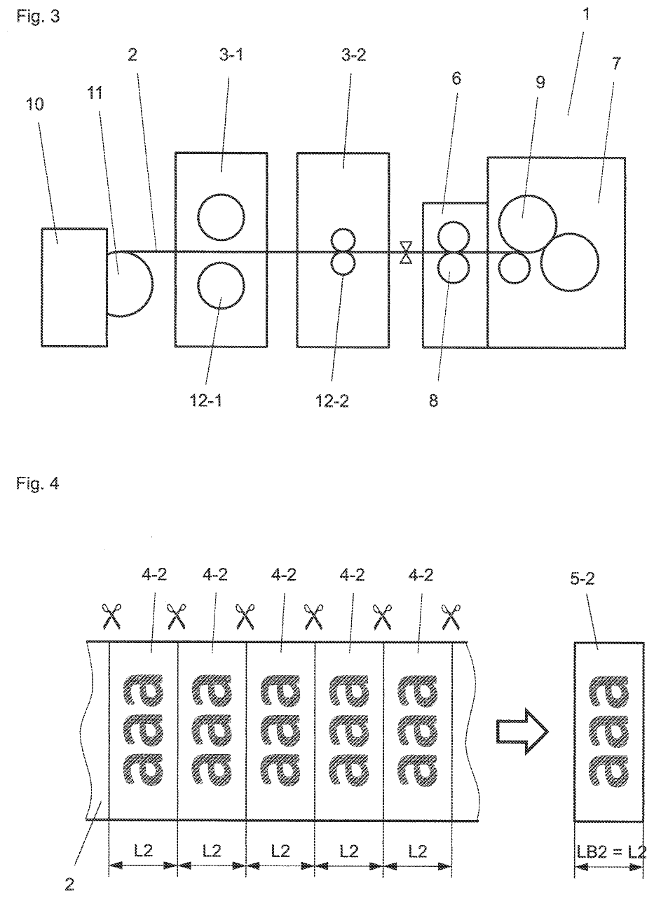

The at least one first printing unit 3-1 and/or the at least one second printing unit 3-2 as well as each further printing unit not illustrated in FIG. 1 or FIG. 3 can be designed as offset printing units or as flexo printing units or as letterpress printing units or as gravure printing units.

FIG. 1 shows a design of a printing press 1, in the case of which a folding device 7 is arranged downstream from the cross-cutting means 6.

A folding device 7 of this type is designed, for example, for optionally collecting and/or for the single or multiple cross-folding and/or for the single or multiple longitudinal folding of the sheets 5, so that variably collected and/or folded signatures can be produced from the sheets 5, which can either be used directly as printed products or which are used as pre-products for products, such as notebooks or books.

The cross-cutting means 6 comprises, for example, a cutting cylinder pair 8, through which the printing material web 2 is guided. One cylinder of the cutting cylinder pair 8 is generally embodied as cutting blade cylinder, the other cylinder of the cutting cylinder pair 8 is embodied as counter cylinder. The variable design of the sheet length LB can thereby be effected by means of a differential speed of the cutting cylinder pair 8 to the speed of the printing material web 2 or by means of a non-uniform rotational movement of the cutting cylinder pair 8.

The folding device 7 comprises, for example, a cylinder group 9 of folding cylinders, which is designed for the format-variable folding of the sheets 5. A cylinder group 9 of this type of folding cylinders can comprise, for example, a collecting cylinder formed as gripper or puncture cylinder, a folding-jaw cylinder for forming one or several cross-folds, a folding blade cylinder, optionally a stapling cylinder for connecting gathered-up sheets 5 and/or at least one longitudinal folding means for longitudinally folding the gathered-up and/or cross-folded signatures.

Due to the fact that FIG. 1 as well as FIG. 3 illustrates the printing press 1 according to the invention only schematically and exclusively with regard to the relevant features, it is mentioned at this point for the sake of completeness that a printing press 1 according to the invention can also comprise all further components known from the prior art, such as drying or hardening means for the printing material web 2, longitudinal cutting means for dividing the printing material web 2 into individual partial webs, a folder superstructure for aligning the partial webs, one or several folder formers for forming longitudinal folds, longitudinal gluing means etc.

FIG. 2 shows a top view onto the printing material web 2, which is printed by means of the first printing unit 3-1. The printing material web 2 is printed with a repetitive first print image 4-1, which is illustrated in an exemplary manner as “AAA” in FIG. 2, wherein each first print image 4-1 has a first print image length L1, which corresponds to the circumference of the first printing cylinder 12-1 and thus the product of the first printing cylinder diameter d1 with the mathematical constant TT. In the case of the example illustrated in FIG. 2, the printing material web 2 is cross-cut by means of the cross-cutting means 6 from FIG. 1 according to each first print image length L1, which is illustrated by means of the symbol of a pair of scissors in FIG. 2. The printing material web 2 is thus divided into individual first sheets 5-1, each first sheet 5-1 has a first sheet length LB1, which corresponds to the example of the first print image length L1 shown in FIG. 2.

Even though not illustrated in FIG. 2, it is thus also possible that the length of the first print image 4-1 is not identical to the first print image length L1, but that a plurality of different first print images 4-1 is printed onto the first print image length L1. It is likewise possible, albeit not illustrated in FIG. 2, that the first sheet length LB1 is not identical to the first print image length L1, but that the first print image length L1 is cross-cut into a plurality of, for example into two, three or four sheets 5. This approach is expedient if either printed products are to be produced, which have a length or width, which is a quotient of the first print image length L1 as numerator and a whole integer as divisor and/or the different print images 4 are gathered up into a multi-layer signature.

FIG. 3 shows the identical printing press 1 of FIG. 1, which is why all above-mentioned embodiments for the design of the printing units 3, of the cross-cutting means 6 and of the folding unit 7 and of all other components or technical properties are also valid for FIG. 3.

The only difference between FIG. 1 and FIG. 3 is that FIG. 3 shows a production, during which the printing material web 2 unrolled from the roll changer 10 is guided in a contact-free manner through the first printing unit 3-1, so that the printing material web 2 is not printed by means of the first printing unit 3-1 but that the printing material web 2 is printed by means of the second printing unit 3-2 because the second printing cylinders 12-2 are in operative connection with the printing material web 2.

Due to the fact that the second printing unit 3-2 comprises second printing cylinders 12-2 with a second printing cylinder diameter d2, wherein the second printing cylinder diameter d2 deviates from the first printing cylinder diameter d1, a second print image 4-2 with a second print image length L2, which is the product of the second printing cylinder diameter d2 and the mathematical constant TT, is thus printed onto the printing material web 2.

Due to the deviation of the second printing cylinder diameter d2 of the second printing unit 3-2 from the first printing cylinder diameter d1 of the first printing unit 3-1, the second print image length L2 thus differs from the first print image length L1.

The printing material web 2 printed in this way by means of the second printing unit 3-2 with a second print image length L2 is subsequently fed to the cross-cutting means 6 for separating the web into sheets 5. If necessary, the sheets 5 can be fed to a folding device 7 for the optional collecting and/or folding, analogously to the explanations relating to FIG. 1.

Analogously to FIG. 2, FIG. 4 shows the printed printing material web 2 in top view, wherein FIG. 4 illustrates the printing material web 2, which is printed by means of the second printing unit 3-2 and onto which the repetitive second print image 4-2 is printed, which is illustrated in an exemplary manner with “aaa”.

Due to the second printing cylinder diameter d2 of the second printing unit 3-2, which is smaller compared to the first printing cylinder diameter d1, the second print image 4-2 applied to the printing material web 2 has a smaller second print image length L2 compared to the first print image length L1, which is why more second print images 4-2 can be applied to an identical section of the printing material web 2.

Each second print image 4-2 has a second print image length L2, which corresponds to the circumference of the second printing cylinder 12-2 and thus the product of the second printing cylinder diameter d2 with the mathematical constant TT. In the case of the example illustrated in FIG. 4, the printing material web 2 is cross-cut by means of the cross-cutting means 6 from FIG. 1 or FIG. 3 according to each second print image length L2, which is illustrated by means of the symbol of a pair of scissors in FIG. 4. The printing material web 2 is thus separated into individual second sheets 5-2, each second sheet 5-2 has a second sheet length LB2, which corresponds to the second print image length L2 in the example shown in FIG. 4.

Even though not illustrated in FIG. 4, it is thus also possible that the length of the second print image 4-2 is not identical to the second print image length L2, but that a plurality of different print images 4-2 is printed onto the second print image length L2. It is likewise possible, albeit not illustrated in FIG. 4, that the second sheet length LB2 is not identical to the second print image length L2, but that the second print image length L2 is cross-cut into a plurality of, for example into two, three or four sheets 5. This approach is expedient if either printed products are to be produced, which have a length or width, which is a quotient of the second print image length L2 as numerator and a whole integer as divisor and/or the different print images 4 are gathered up into a multi-layer signature.

The printing press 1 illustrated in FIG. 1 and FIG. 3 is thus suitable for carrying out a method for producing unfolded or folded sheets 5 with at least a first sheet length LB1 or a second sheet length LB2, during which the printing material web 2 is either printed by means of an at least one first printing unit 3-1 with a first print image 4-1 with a first print image length L1 or by means of an at least one second printing unit 3-2 with a second print image 4-2 with a second print image length L2. The printing material web 2 printed optionally in this way is separated after the printing by means of a cross-cutting means 6 into sheets 5 with a sheet length LB, wherein the sheet length LB is set to the first print image length L1 or to the second print image length L2 or to a sheet length LB as quotient of the first print image length L1 or of the second print image length L2 as numerator and a whole integer greater than zero as divisor as a function of the performed first print image length L1 or of the second print image length L2. A method of this type can be expanded with the optional printing of the printing material web 2 with at least a third printing unit 3-3 with a third print image length L3 and/or at least a fourth printing unit 3-4 with a fourth print image length L4 and further printing units 3 with further print image length L.

For this purpose, the printing material web 2 can be guided in a contact-free manner through the at least one second printing unit 3-2 or around the at least one second printing unit 3-2, in the case that said printing material web is printed by means of at least one first printing unit 3-1. In the other case that the printing material web 2 is printed by means of the at least one second printing unit 3-2, the printing material web 2 is either guided in a contact-free manner through the at least one first printing unit 3-1 or around the at least one first printing unit 3-1.

Downstream from the cross-cutting means 6, the sheets 5 separated in this way can optionally be collected and/or cross-folded and/or longitudinally folded by means of a folding device 7 arranged downstream from the cross-cutting means 6.

The folding device 7 required for this purpose, which is designed as format-variable folding device 7 and which is thus suitable to process different sheet lengths LB, is optionally set to the first sheet length LB1 or to the second sheet length LB2 or to a quotient of the first print image length L1 or of the second print image length L2 as numerator and a whole integer greater than zero as divisor.

That which is claimed is:

1. A printing press for printing a printing material web, the printing press comprising:
at least one first printing unit for at least one-sided printing of the printing material web with a first print image with a first print image length, wherein the at least one first printing unit is configured for the print-free guide-through or guide-around of the printing material web;
at least one second printing unit for at least one-sided printing of the printing material web with a second print image with a second print image length deviating from the first print image length, wherein the at least one second printing unit is configured for the print-free guide-through or guide-around of the printing material web; and
a cross-cutting means, which is formed for separating the printing material web into sheets with a sheet length, wherein the sheet length corresponds to the first print image length or to the second print image length or to a quotient of the first print image length or of the second print image length as numerator and an integer of greater than zero as divisor.

2. The printing press according to claim 1, wherein the at least one first printing unit and/or the at least one second printing unit are configured with an invariable print image length.

3. The printing press according to claim 1, wherein the at least one first printing unit and/or the at least one second printing unit are configured with a variable print image length.

4. The printing press according to claim 1, wherein the first printing unit and/or the second printing unit are configured as offset printing units or as flexo printing units or as letterpress printing units or as gravure printing units.

5. The printing press according to claim 1, wherein a folding device is arranged downstream from the cross-cutting means.

6. The printing press according to claim 5, wherein the folding device is configured for collecting and/or cross-folding and/or longitudinal folding of the sheets.

7. The printing press according to claim 1, wherein the cross-cutting means comprises a cutting cylinder pair and is configured for producing different sheet lengths.

8. The printing press according to claim 5, wherein the folding device comprises a cylinder group of folding cylinders, wherein the cylinder group is configured for the format-variable folding of the sheets.

9. A method for producing unfolded or folded sheets with at least a first sheet length or a second sheet length, wherein a printing material web is either printed by means of an at least one first printing unit with a first print image length or by means of an at least one second printing unit with a second print image length, wherein the printing material web is separated after the printing by means of a cross-cutting means into sheets with a sheet length, wherein the sheet length is equal to the first print image length or to the second print image length or is equal to a quotient of the first print image length or of the second print image length as numerator and with a whole integer greater than zero as divisor as a function of the performed first print image length or of the second print image length.

10. The method according to claim 9, wherein downstream from the cross-cutting means, the sheets are collected and/or cross-folded and/or longitudinally folded by means of a folding device arranged downstream from the cross-cutting means.

11. The method according to claim 9, wherein the printing material web is guided in a contact-free manner through the at least one second printing unit or around the at least one second printing unit such that said printing material web is printed by means of the at least one first printing unit.

12. The method according to claim 9, wherein the printing material web is guided in a contact-free manner through the at least one first printing unit or around the at least one first printing unit such that said printing material web is printed by means of the second printing unit.

13. The method according to claim 10, wherein the folding device is configured as a format-variable folding device and is set to the first sheet length or to the second sheet length or to a quotient of the first print image length or of the second print image length as numerator and a whole integer greater than zero as divisor.
